(19) United States
(12) Patent Application Publication
(10) Pub. No.: US 2017/0251625 A1
(43) Pub. Date: Sep. 7, 2017

(54) METHOD AND DEVICE FOR REMOVING A PLASTIC COATING FROM A BLOCK OF FOOD

(71) Applicant: BMA Automation GmbH, Braunschweig (DE)

(72) Inventor: Dirk Seebaum, Merzhausen (DE)

(21) Appl. No.: 15/510,775

(22) PCT Filed: Sep. 16, 2015
(86) PCT No.: PCT/EP2015/071201

§ 371 Date: Mar. 13, 2017

(30) Foreign Application Priority Data
Sep. 16, 2014 (DE) 102014113323.4

(51) Int. Cl. A01J 27/00; B23K 26/361; B23K 26/08

(52) U.S. Cl. CPC A01J 27/00; B23K 26/083; B23K 26/361; B23K 2201/34

(57) ABSTRACT

A method for removing a plastics coating from a block of food, in particular a whole cheese, operates with the following steps: the block of food, in particular the whole cheese with its plastics coating is fed to the method. A laser beam is then directed onto the plastics coating of the block of food. Herein the output of the laser which emits the laser beam is adjusted so that a removal of the plastics coating takes place by separation of a region of the plastics coating and/or by erosion or vaporisation of the plastics coating. A device for removing a plastics coating from a block of food, in particular a whole cheese, comprises a transport apparatus for the block of food and a laser apparatus for applying a laser beam to the block of food.

The invention relates to a method for removing the plastics coating from a block of food, in particular from a whole cheese. The invention also relates to a device for removing the plastics coating from a block of food, in particular from a whole cheese.

In the production of blocks of food, a plastics coating is often applied externally. This is the case, in particular, in the production of hard and semi-hard cheeses. In their production, a maturing process is carried out which is critical for the specific quality of the cheese to be produced. This maturing process often makes it necessary that the cheese is provided with a plastics coating to protect it against drying out and, in some circumstances, also for protection against mould growth and other external influences. This step is also designated plastifying.

The plastics coating of the block of food is also designated the rinding or rind of the block of food.

Following the performance of the maturing process, it is usually required that this plastics coating is removed before a further processing of the cheese can then be carried out. This removal is also designated de-plastifying or de-rinding of the cheese. Following the removal of the plastics coating, the cheese is then cut or subdivided into smaller blocks suitable for sale or is put on sale directly, ready for cutting. It is herein often required that the plastics coating is completely removed as inedible or undesirable, whilst at the same time, the smallest possible loss of the saleable and edible constituents of the block of food is to take place since such a loss naturally reduces the sale value of the whole cheese.

The food industry has long concerned itself with this removal of the plastics coating. Thus, in DE 33 05 668 A1, it is proposed to carry out this de-rinding or peeling by cutting or scraping wherein the cheese is compressed perpendicularly to the processing direction in order to keep the cutting surfaces largely flat and thus to keep the losses small.

From DE 197 35 595 A1, there is known a proposal for removing the coverings of food products such as whole cheeses in which rollers with profiled outer surfaces are provided for grasping and pulling off the coverings. However, such rollers are not suitable for all plastics types and particularly not if a particularly strong mechanical connection of the plastics coating to the cheeses has taken place.

From EP 1 800 542 B1, there is known a device for removing the plastics coating from cheese wherein during the peeling operation, the temperature of the plastics coating is set to a range that lies above the glass transition temperature, but below 30° C. This temperature is to be achieved, where possible, by infrared heat treatment. Here also, where possible, rotating rollers are provided in the device for the mechanical peeling operation.

All these mechanical peeling devices, including those with cutting knives and comparable apparatuses are very complex. It should be taken into account herein that the whole cheeses made during cheese production have diameters of significantly more than a metre, and also sometimes more than two metres and that therefore corresponding weights must be moved and lengths cut off. It should also be taken into account that through excessive cutting losses, significant value passes to the food waste and must then also be disposed of in a costly manner. The dimensions of different blocks of food, including among the same type or from the same producer differ significantly and make necessary complete resettings of the very complex mechanical elements if an optimal cut or an optimal milling is to take place.

Additionally, the corresponding apparatuses are very expensive and complex and it is often not possible to keep them at the site of the production of the relevant block of food. This, in turn, has the effect that significant costs have to be borne for the transport of the heavy blocks of food to these removal stations for the plastics coating wherein, furthermore, subsequently return transport for the next process step of cutting and packaging for the further distribution in the food trade also arises.

It is therefore an object of the invention to propose a method and a device with which an alternative possibility for removal of the plastics coating of a block of food is provided.

This object is achieved according to the invention with a method for removing a plastics coating from a block of food, in particular a whole cheese, comprising the following steps:

a) the block of food, in particular the whole cheese, with a plastics coating is fed to the method,

b) a laser beam is directed at the plastics coating of the block of food, and

c) the output of the laser which emits the laser beam is adjusted so that a removal of the plastics coating takes place by separation of a region of the plastics coating and/or by erosion or vaporisation of the plastics coating.

In a device, this object is achieved according to the invention by an apparatus for removing a plastics coating from a block of food, in particular from a whole cheese, comprising

a) a transport apparatus for the block of food,

b) a laser apparatus for applying a laser beam to the block of food.

By means of the invention, there is provided an innovative and economical method for de-plastifying whole cheeses, that is for removing the plastics coating with which cheeses have previously been surrounded.

In a completely different context, from DE 38 36 821 A1, EP 0 421 837 B1 and U.S. Pat. No. 5,120,928 A, it is known to mark the surface of cheese or sausage products with markings by means of a laser, for example to identify the type of a food or to apply bar codes or brand marks or other information relating to the production firmly onto the block of food. Herein, local heating of the uncovered block of food by means of the laser beam is undertaken, such that it assumes a light brown coloration. Removal of portions of the block of food or even of a rind or a covering is therein not envisaged and the methods described would also not be suitable therefor.

The power outputs of the lasers to be provided according to the invention which are to output the laser beam are from a thousand times to ten thousand times the power of the laser beams of the lasers used for marking blocks of food.

According to the invention, the block of food is also not treated itself, but rather the plastics covering, also designated a plastics coat, is removed.

Two possibilities exist in order, with the help of a laser beam, to remove the plastics coating of the blocks of food. Firstly, the laser beam can be used like a type of knife for separating the unwanted outermost layers of the cheese, thus particularly the plastics coating, wherein the precise positions can be selected by means of measuring methods and control of the laser.

Secondly, the laser beam can also be used for erosion of the plastics coating. In particular, a vaporisation of the material of the plastics coating by the laser beams comes into consideration. This means that it melts or vaporises the plastics coating from outside and in this way erodes and removes the plastics coating from outside in the direction toward the centre of the cheese. The progress of this movement can also accordingly be followed by measurement and controlled.

In addition to a vaporisation of the material of the plastics coating a combustion of the material also comes into consideration.

Laser beams have a great advantage. In accordance with the invention, they feed in a relatively large quantity of energy, which is sufficient for vaporisation of the material of the plastics coating, but only very briefly. The plastics material is then vaporised and no longer present around the cheese. However, this also means, as distinct from a longer-term heating, for example, by conductive heat input, no impairment of the cheese or other food of the corresponding block takes place. It is not or is only slightly heated and is therefore not altered in its taste.

It is particularly preferred if a laser beam of a CO₂ laser is used. CO₂ lasers operate with a wavelength of approximately 10.6 μm. At this wavelength, particularly in polymer materials, that is in rinds made of polymer plastics, as are often used with blocks of food, a very high level of absorption can be achieved. Furthermore, a high output with a good beam quality is available in such lasers. It follows from this that high power densities are possible. The investment costs for such lasers are also reasonable and they are therefore economically producible. CO₂ lasers are also well tried and reliable in operation.

Preferably, a selective regulation of the laser power takes place in order to remove the plastics coating completely.

It is herein provided, in particular, that the output of the laser which emits the laser beam is adjusted so that a complete removal of the plastics coating takes place by complete separation of the plastics coating.

In another alternative embodiment, targeted removal or co-combustion or co-vaporisation of the matrix of the block of food, thus in particular, the cheese matrix takes place in order to ensure that plastics coating present in depressions due to unevennesses of the surface of the block of food is also removed. In this embodiment, regions irradiated by the laser are thus themselves specifically placed as far as into the outermost layers of the block of food itself in order to ensure complete removal.

In these embodiments, surface regions of the block of food are in fact also removed, which leads to slight losses of corresponding material of the block of food. However, the quality of the remaining block of food increases in that it can be excluded with certainty that plastics coating residues still remain. The processing limit is effectively displaced toward the safe side into the food.

It is also possible to process the same area regions multiple times to expose a residue-free surface of the block of food.

By specific selection of the laser sources, defined output ranges can be selected with specific laser intensities.

Laser operation is possible both in a continuous wave (CW) mode or in pulsed operation. A combination of both operating types is also conceivable if it is usefully employable for special surface forms or particular rind materials of the blocks of food. The operating type can be selected having regard to the processing results and regulating possibilities and the laser parameters can be adapted accordingly.

The corresponding laser removal methods are capable of fulfilling all the food standards. Herein, the different power levels of different lasers and also the adjustability can be utilised. Different feed speeds can be used. The focus position of the laser is also adjustable and can be aligned with the optimal distance of the plastics coating.

Furthermore, the processing can be supported with scanner optics. These optics can comprise a plurality of movable mirrors and transmissive optical elements and in this way enable rapid beam guidance and focus tracking relative to the processed surface, specifically both laterally and orthogonally.

In this context, both portal systems with a static as well as with a moving workpiece are conceivable. The scanner optics can be moved linearly over the workpiece or alternatively, the workpiece can be moved linearly under a fixed scanner optics. Also possible are systems with scanner optics that are movable in space which are actuated, for example, by means of handling robots.

It is thereby possible to work with restricted processing areas or processing fields in the region of the rinds of the blocks of food. Herein, a processing sequence takes place which places individual processing surfaces against one another such that border regions lying therebetween are removed without residue. For this purpose, processing strategies can also be used which enable the targeted removal in regions of adjoining processing fields.

In addition, a spacing measuring apparatus can be used which is directed coaxially with the laser beam to the workpiece surface. Alternatively or additionally, the spacing measuring apparatus can also be arranged laterally and the spacing of the scanner optics from the incidence point of the laser can be measured. Herein, optical methods by means of transit time measurement or triangulation are preferred.

A further possibility in embodiments of the invention consists in the prior detection of the surface. This can take place, for example, by means of camera systems which enable a detection and measurement of the surface topography.

With similar methods, not only can a control system of the laser processing system be used, but this surface detection can also be used additionally or alternatively for quality assurance purposes, for example, in order to recognise automatically defects or particular markings or other properties on whole cheeses.

Further embodiments have measuring and regulating apparatuses with which optical feedback from the processing procedure can be detected in real time. This can be used for a rapid regulation of the laser power density, that is, for a regulation of the laser power and/or the focus position. The energy per unit length, that is, the ratio of laser power to feed speed, can thus be regulated.

The measuring and regulating apparatuses can herein detect, for example, characteristic spectral lines of the processing procedure, preferably from the thermal process of an erosion of the plastics coating of the block of food. These characteristic spectral lines can then be utilised for a regulation.

It is particularly preferred if a gas is fed to the laser beam in the region of the incidence on the block of food, in particular a protective gas and/or a gas supporting the removal procedure and/or a gas reducing the adhesion of removed material on the remaining food item.

By this means, firstly, the food itself is protected and, secondly, the environment and any persons situated there can be protected against the removed residues.

A targeted feeding of corresponding process gases, in particular air or oxygen or mixtures with these gases can be utilised for improved vaporisation and also oxidation with combustion of the plastics coating and simultaneously also for reducing so-called redeposits, that is, of combustion residues.

In experiments, it has been found that with an increasing oxygen content in the gas fed in, the emissions of highly volatile hydrocarbons decrease. The processed surface of the block of food following the procedure according to the invention becomes more homogeneous with use of gases with an increasing oxygen content. It therefore involves fewer redeposits.

Further tests have shown that a cooling effect can also be caused by the gases fed in, which can have a negative influence on the combustion and/or the emissions occurring. This can naturally be taken into account accordingly in further embodiments.

A high surface output is possible and the plastics coating is completely removable.

In one embodiment, it is further provided to provide an automatic recognition of non-coated surface regions of the blocks of food. By this means, a double treatment can automatically be prevented.

A further embodiment provides that coloured pigments are introduced into the plastics coating or, under some circumstances, also into the surface of the matrix of the block of food, in particular dark pigments. In this way, a greater absorption of the laser energy applied can be brought about and simultaneously, an optimisation of the combustion or vaporisation of the plastics coating can be brought about.

The coloured pigments are “dark” in the sense of having a good absorption of the laser power of the specifically employed laser. With the use of CO₂ lasers, for example, light organic or water-containing materials can be used as such coloured pigments.

In further embodiments, a postprocessing of the treated block of food, thus in particular the whole cheese, can be carried out by means of a fluid medium. This can be realised, for example, in a step of dipping into or rinsing with brine.

It is also possible to carry out a postprocessing of the processed and removed rind of the block of food, for example, by brushing the processed surfaces in order by this means to remove processing and/or coating residues.

With the measures proposed according to the invention, a very rapid processing of processing areas of 2,500 mm² is possible. The processing of very large processing areas can preferably take place through scanning of the laser beam. This scanning takes place, for example, in a meandering form in order to realise with a very high surface output, that is, a high output of area per unit time, a removal of large surface regions in the shortest time by the scanning of lines or points.

The processing times for this can be reduced to periods of less than 1 second. The processing areas are designed so that they adjoin one another.

In further embodiments, it is provided to detect and to analyse the emissions from the processing procedure for monitoring the processing result and the product quality. This can be undertaken in situ or subsequently, and used for measures of quality assurance and traceability.

It is also possible to analyse the smoke gases arising from a drawing off of the residues and to characterise their emission. Naturally, following the removal of the coating, the cheese or other food can be investigated accordingly and subjected to taste tests in order to draw conclusions about changes to the setting of the laser beams.

It is further advantageous if, following the execution of the method, a quality assurance step is carried out.

It is also possible to remove very different plastics coatings in this way. If required, the laser employed or the parameters used are to be adapted accordingly.

Test results have shown that no worsening of the different laser-treated blocks of food takes place as compared with untreated similar blocks of food.

It has been found in tests to be possible to de-plastify areas of 2,500 mm² or more seamlessly.

The invention also provides further new possibilities for the plastics coatings themselves. Thus, the plastics coatings can prepared or selected in advance for a particularly good effect of the laser beams. The polymer layers mostly used in the plastics coatings can be adapted so that they have an enhanced sensitivity in the absorption for the laser beam used. This can take place either through an adjusted corresponding polymer composition or through the inclusion of absorption-enhancing pigments into the polymer layers of the plastics coating. The laser wavelengths can also be tuned to these pigments or, generally, to the selection of the plastics coating. By this means, an interesting interplay is possible which can be used for an optimum later removal of the plastics coating.

In particular, as a consequence, there arises a selective removal of the plastics coating and a particularly low level of influence on the block of food, in particular the whole cheese, surrounded by the plastics coating.

1. Method for removing a plastics coating from a block of food, in particular a whole cheese, comprising the following steps:
a) the block of food, in particular the whole cheese, with a plastics coating is fed to the method,
b) a laser beam is directed at the plastics coating of the block of food, and
c) the output of the laser which emits the laser beam is adjusted so that a removal of the plastics coating takes place by separation of a region of the plastics coating and/or by erosion or vaporisation of the plastics coating.

2. Method according to claim 1,
characterised in that,
the output of the laser which emits the laser beam is adjusted so that a complete removal of the plastics coating takes place by complete separation of the plastics coating.

3. Method according to claim 1,
characterised in that,
a targeted removal of the outermost regions of the matrix of the block of food takes place.

4. Method according to claim 1,
characterised in that
the laser beam is a CO₂ laser beam.

5. Method according to claim 1,
characterised in that
the laser beam is moved and sweeps over the block of food successively, and/or
in that the block of food moves and, by means of the movement, is successively exposed to the laser beam.

6. Method according to claim 1,
characterised in that
the laser beam is applied in continuous wave mode and/or in pulsed manner to the block of food.

7. Method according to claim 1,
characterised in that
a guidance of the laser beam is carried out by means of optical elements, in particular one or more moved mirrors and/or one or more of transmissive optical elements relative to the surface to be processed of the block of food.

8. Method according to claim 1,
characterised in that
during or following the feeding of the block of food to the method, a measurement of the geometry, in particular the spacing of the block of food from the laser beam takes place, and
in that the values of this measurement are fed to a control apparatus which undertakes a tracking of the laser beam and/or of the block of food.

9. Method according to claim 8,
characterised in that
in the control apparatus, depending on the speed of removal by the laser beam that is to be observed, a regulation of the laser output and/or the speed of the movement of the block of food takes place.

10. Method according to claim 1,
characterised in that
a gas is fed to the laser beam in the region of the incidence on the block of food, in particular a protective gas and/or a gas supporting the removal procedure and/or a gas reducing the adhesion of removed material on the remaining food.

11. Method according to claim 1,
characterised in that
in the region of the incidence of the laser beam on the block of food, a drawing off of gas and of removed material takes place.

12. Method according to claim 11,
characterised in that
the gases drawn off, the ambient air and the process emissions are filtered.

13. Method according to claim 1,
characterised in that
before the further processing of the block of food and following the removal of the plastics coating, an in particular mechanical and/or pneumatic cleaning of the surface of the remaining block of food takes place, in particular by brushing off processing and coating residues.

14. Method according to claim 1,
characterised in that
following the execution of the method, a quality assurance step is carried out.

15. Method according to claim 14,
characterised in that
an identification and marking of the incoming and outgoing blocks of food is carried out for product and/or batch tracking.

16. Method according to claim 1,
characterised in that
an automatic recognition of non-coated surface regions of the block of food takes place.

17. Method according to claim 1,
characterised in that
coloured pigments, in particular dark pigments are introduced into the plastics coating or into the surface of the matrix of the block of food, before the performance of the method, resulting in a greater absorption of the laser energy.

18. Device for removing a plastics coating from a block of food, in particular a whole cheese, comprising
a) a transport apparatus for the block of food,
b) a laser apparatus for applying a laser beam to the block of food.

19. Device according to claim 18,
characterised in that
a guidance of the laser beam is carried out by means of optical elements, in particular one or more moved mirrors and/or one or more of transmissive optical elements relative to the surface to be processed of the block of food.

20. Device according to claim 18,
characterised in that
during or following the feeding of the block of food, a measurement of the geometry, in particular the spacing of the block of food from the laser beam takes place, and
in that the values of this measurement are fed to a control apparatus which undertakes a tracking of the laser beam and/or of the block of food,
in the control apparatus, depending on the speed of removal by the laser beam that is to be observed, a regulation of the laser output and/or the speed of the movement of the block of food takes place.
